(19) United States
(12) Patent Application Publication
(10) Pub. No.: US 2025/0271065 A1
(43) Pub. Date: Aug. 28, 2025

(54) BALL VALVE OF A REFRIGERANT VALVE DEVICE FOR AN AIR CONDITIONING SYSTEM

(71) Applicant: HANON SYSTEMS, Daejeon (KR)

(72) Inventors: Péter Hirt, Budapest (HU); Zoltán Horváth, Iszkaszentgyörgy (HU); Tamás Kiss, Iszkaszentgyörgy (HU); István Pajor, Székesfehérvár (HU)

(21) Appl. No.: 18/855,238

(22) PCT Filed: Jul. 10, 2023
(86) PCT No.: PCT/KR2023/009735

§ 371 Date: Oct. 8, 2024

(30) Foreign Application Priority Data
Jul. 14, 2022 (DE) 102022117627.4
Jun. 30, 2023 (DE) 102023117369.3

(51) Int. Cl. F16K 5/06; F16K 27/06; F25B 41/20

(52) U.S. Cl. CPC F16K 5/0605; F16K 27/067; F25B 41/20

(57) ABSTRACT

A ball valve of a refrigerant valve device for an air conditioning system including a ball valve housing of two housing parts, which each have an L-shaped cross-sectional geometry, are aligned rotationally symmetrically with respect to one another and are connected to one another at their ends with the help of fastening elements to form a ball valve housing with a rectangular cross-sectional geometry, with two mutually opposite housing side walls, a bottom wall and with an upper housing wall opposite to the bottom wall and with two mutually opposite open sides, wherein the ball valve housing has a fluid inlet formed in the bottom wall and two fluid outlets formed in the mutually opposite housing side walls, a ball arrangement which contains a through-flow control ball as well as sealing seats and inner sealing elements and is held together by the ball valve housing.

### CROSS REFERENCE TO RELATED PATENT APPLICATIONS

This is a U.S. national phase patent application of PCT/KR2023/009735 filed Jul. 10, 2023, which claims the benefit of and priority to German Patent Application No. 10 2023 117 369.3, filed on Jun. 30, 2023, and German Patent Application No. 10 2022 117 627.4, filed on Jul. 14, 2022, the entire contents of each of which are incorporated herein by reference for all purposes.

### TECHNICAL FIELD

The invention relates to a ball valve of a refrigerant valve device for an air conditioning system, in particular a motor vehicle air conditioning system. The refrigerant valve device comprises at least one ball valve and can be operated in a refrigerant system with the refrigerant R134a (1,1,1,2-tetrafluoroethane) or R1234yf (2,3,3,3-tetrafluoropropene). The inlet of a ball valve embodied as a 3/2-way valve is located at the bottom, the fluid outlets are placed on two opposite sides. The fluid outlets must be separated from each other as well as from the inlet by sealing. The difference in the operating pressure is usually in the range of 5 and 30 bar.

### BACKGROUND ART

The ball valve described here is provided for the application in a cartridge valve as a valve device. The principle of the cartridge valve is that several valves of the refrigerant system are arranged in a valve block, wherein the largest part of the refrigerant system is also located within this block. The assembly and disassembly of the valves in the valve block should be quick and easy in order to make these systems easy to maintain. In this concept, a seal between the valve block and the valve or a housing of the valve is required. Usually, outer O-rings are provided for the sealing, however, these may pose a problem during assembly and transport of the valve device. The cartridge concept was originally developed for needle valves, which, however, can only be operated as two-way valves. A 3/2-way ball valve can guide the refrigerant flow in several directions, and the refrigerant flow at an outlet could even be regulated with an expansion joint if provided. This means that such a 3/2-way ball valve could possibly even replace two needle valves in one system. Cartridge ball valves are already known from the prior art, both for 3/2-way operation and for two-way operation.

In WO 001999061824 A1, a device with a ball valve is described which has a valve body with aligned through-channels which end at opposite ends with flanges for installation in a flow line. A truncated cavity is formed between the flow channels on a central axis perpendicular thereto in such a way that it can receive an insert assembly which comprises a cartridge of two semi-circular half shells which are connected by connecting elements and are held in the valve body by a valve upper part. The insert assembly contains a valve ball and opposite seat rings within the cartridge formed by the separable half shells. The matching half shells are connected to each other on both sides of the valve ball and thereby form a truncated cone shape corresponding to the cavity. A cylindrical spring seal is attached to each of the seat rings in a length section with a reduced diameter of the seat ring. The spring seals are each compressed between shoulder regions of the seat rings and annular depressions in the cartridge facing them and press the seat rings into dynamic sealing contact with the valve ball. The spring seals also provide a static sealing at the interfaces between the seat rings and the cartridge. Connecting pieces on the connecting surfaces of the valve upper part and the insert assembly make it possible to remove the insert assembly with the valve upper part completely from the valve body in order to allow easy access for the repair or the exchange of components within the cartridge. Each half shell contains an opening for the connection between the through-channels. The valve ball has engagement surfaces and a lower and an upper bearing journal for rotation in bushings on an axis perpendicular to the longitudinal direction of the through-channels and, in addition, has a bore through the valve ball which has the same diameter as the through-channels and is aligned with the openings when the valve ball is rotated by 90 degrees from a closed into a fully open position. Annular seals, which are attached to the curved half shell surfaces of the truncated cartridge around the openings, are intended to prevent liquid from escaping from the through-channels through the interface between the cartridge and the valve body.

A similarly constructed valve, which comprises a valve body and a valve assembly

arranged in the valve body, is also known from US 2008 00 99 712 A1, wherein the construction is intended to make maintenance on site possible without the entire valve having to be removed from a pipeline system. The valve assembly comprises a main cartridge and an upper cartridge, wherein the main cartridge is composed of two cartridge halves, and wherein a ball valve arrangement with the ball valve and a shaft is arranged between the cartridge halves. The ball valve has an opening so that liquid can flow through the ball valve when the ball valve is in an open position. The ball valve can also be rotated into a closed position in which no liquid can flow through the opening by rotating the shaft connected to the ball valve and thus the ball valve itself by a quarter turn or by 90 degrees. The shaft can be formed in one piece with the ball valve or can be formed separately and fastened to the ball valve. There is a respective seal on both sides of the ball valve. The seals are designed in such a way that they correspond at least substantially to a radius of curvature of the ball valve, so that the ball valve can rotate smoothly between the seals, while the seals are intended to ensure a liquid-tight seal against the ball valve. The seals are each of annular design, so that they do not restrict, or at least do not substantially restrict, the flow of liquid through the opening when the ball valve is in an open position. The cartridge halves can each be configured in such a way that they can receive a respective one of the seals. Each cartridge half has an inner surface which has an annular depression with a profile complementary to the received seal, so that the seal can fit into the annular depression. The cartridge halves each have a curved outer surface which has an annular depression for receiving an O-ring. The O-rings in the annular depressions also play a role in positioning and securing the main cartridge in the valve body. Furthermore, an O-ring is fastened in an annular recess on the underside of the upper cartridge. This O-ring provides for a liquid-tight sealing between the main cartridge and the upper cartridge.

The valves mentioned have in common that a valve ball is completely enclosed by an at least two-part cartridge housing which has a conical or cylindrical outer surface. A first cartridge housing and a second cartridge housing are locked together and thus enclose the ball. On the outer curved surfaces of the first and second cartridge housing, a respective O-ring is placed as a sealant. This means that both valves conform to a concept which uses a two-part housing and outer seals at the two outlets. The main objective to be achieved with such valves in each case is that the valve can be replaced and/or removed from a system without the entire system having to be disassembled.

In DE 7902845 U, a ball valve with a tap body is disclosed, which has at least one through-flow channel extending between openings, into which a rotatable ball plug with a through-flow bore, which bears against at least one seal, is inserted and on which a switching spindle connected to a switching handle outside the tap body engages for its rotation. In this case, the tap body is inserted into the cavity of a rigid tap housing, while its mouths are externally sealed against one another, and can be removed through a housing window. The tap housing, for its part, has through-flow openings with pipe connection possibilities at the location of the mouths of the tap body. The tap housing has a window in the region of the extended axis of the switching spindle and the tap body can be pushed into the window in the direction of this axis, thus closing it, or pulled out of it in the direction of this axis. The tap body and the cavity of the tap housing can substantially have a circular cylindrical shape or a conical shape, wherein the tap body is rotatable in the cavity of the tap housing at least by a central angle which is limited by the condition that the mutual sealing of the mouths of the tap body must not come into contact with the through-flow openings of the tap housing. In the cavity of the housing, the tap body can rest against the inner wall thereof with the interposition of sealants between the mouths and between the mouths and the window. There are endless grooves in the outer surface of the valve body which serve to receive the sealants. The sealants can be arranged between complementary steps arranged on the inner wall of the tap housing on the one hand and on the outer wall of the tap body on the other hand. Seals are located on the outer surface of the tap body between the mouths or between the through-flow openings and can be designed in the shape of an O-ring which seals the two ends of the through-flow channel against one another. The O-ring is inserted into a groove which lies along the lateral surface of the tap body in an oblique plane, i.e. is elliptical. Like the above-mentioned two-part or multi-part cartridge housings, the tap body enclosing the ball plug forms a conically shaped housing, but in contrast to the cartridge housings, this housing is formed in one piece. The sealing of the two ends of the through-flow channel, i.e. of the inlets, on the one-piece cock tap housing with the diagonal O-ring lying in an oblique plane does work, but for this purpose it is necessary for the tap body housing to completely surround the ball plug.

All of the above-mentioned objects from the prior art relate to valve bodies or tap bodies which each contain a ball and are employed in the manner of valve cartridges. The fact that, in the solutions presented, a housing of the valve body or the tap body must completely enclose the ball causes several disadvantages, as mentioned below:
a high material requirement for the housing,
a lot of scrap material during production,
high manufacturing and material costs,
an elaborate housing construction for use within a cartridge concept,
a high weight of the valve due to the material used for the complete enclosure.

### SUMMARY

The object of the invention is to provide a valve which utilizes the cartridge concept but requires less material, thereby also having less weight and, in addition, can be produced more cost-effectively.

The object is achieved by a ball valve of a refrigerant valve device for an air conditioning system, wherein the ball valve has at least the features shown and described herein.

A ball valve according to the invention comprises a ball valve housing of two housing parts, each having an L-shaped cross-sectional geometry. These two L-shaped housing parts are aligned rotationally symmetrically with respect to one another and are connected to one another at their ends with the help of fastening elements to form a ball valve housing with a rectangular cross-sectional geometry, with two opposite housing side walls, a bottom wall and with an upper housing wall opposite to the bottom wall and with two opposite open sides. According to the invention, the ball valve housing is thus designed as an open housing and has a fluid inlet formed in the bottom wall and two fluid outlets formed in the mutually opposite housing side walls. The two housing parts are preferably clamped together with the help of screws.

In addition, the ball valve according to the invention comprises a ball arrangement which contains a through-flow control ball as well as sealing seats and sealing elements, such as O-rings, for example, and is held together by the ball valve housing as a “ball pack”. With this ball arrangement of O-rings, sealing seats and the through-flow control ball between the two housing side walls, the interior of the ball valve according to the invention is thus similar to the interior of already known 3/2-way cartridge valves.

A through-flow channel with a bottom opening directed towards the fluid inlet and with a lateral opening extends through the through-flow control ball. The through-flow control ball is rotatable about an axis perpendicular to the bottom wall, as a result of which the position of the lateral opening of the through-flow control ball is adjustable with respect to the fluid outlets. This means that the ball valve is embodied as a 3/2-way ball valve which can guide the fluid flow, for example a coolant flow, by aligning the lateral opening of the through-flow control ball towards the various fluid outlets in different directions. The through-flow channel is preferably embodied at right angles. According to an advantageous design, the lateral opening of the through-flow control ball can comprise differently shaped sections, for example a round section which transitions into a gap section on one side. As a result, it is possible to regulate a fluid flow at each of the two fluid outlets, i.e. in one direction.

According to the invention, the two spaced and mutually opposite housing side walls are curved and aligned on their outer sides in the manner of two opposite segments of a downwardly tapering truncated cone. A respective sealing ring which extends around the opening of the fluid outlet in the corresponding housing side wall is attached to the curved outer sides of the two housing side walls.

In the context of this invention, the ball valve housing is referred to as “conical” because of the curved shape and orientation of the outer sides of the opposite housing side walls, although there is no complete conical shape extending over the entire circumference of the ball valve housing, but rather a housing which is open to two opposite sides. The ball valve housing is conical in the region of the outer sides of its housing side walls since these outer sides are curved and aligned in the manner of oppositely orientated outer surfaces of opposite segments of a downwardly tapering cone or truncated cone. The cone angle of the ball valve housing, which tapers conically in the region of its curved outer sides and corresponds to half the cone angle of a truncated cone with corresponding, mutually opposite truncated cone segments, is preferably approximately 7°, i.e. 7°+0.5°.

On the curved outer sides of the housing side walls, a respective annular receiving recess is preferably formed for the respective one sealing ring. Advantageously, the respective receiving recess for the corresponding lateral sealing ring is formed on the curved outer sides of the housing side walls in such a way that the receiving recess is aligned perpendicularly to the surface of the curved outer side in each direction. This means, among other things, that in each cross-sectional representation in which the receiving recess appears to be U-shaped, each U-limb extends in each case perpendicularly to the surface of the outer side of the ball valve housing or perpendicularly to a tangent of the curvature of the outer side of the housing side wall of the ball valve housing which bears against the U-limb. This alignment of the receiving recess ensures that the lateral sealing ring is neither lost nor slips out of the receiving recess.

Usually, the ball valve further comprises a shaft for driving the through-flow control ball, wherein this shaft is passed through a passage opening in the middle of the upper housing wall and is connected to the through-flow control ball or is in operative connection with the through-flow control ball. The shaft can be formed in one piece with the through-flow control ball or can be formed separately and fastened to the through-flow control ball. An operative connection between the shaft and the through-flow control ball can be realized in that the shaft has at its end directed towards the through-flow control ball an engagement element projecting in the axial direction of the shaft, which engages in a corresponding recess of the through-flow control ball.

Further, the ball valve can comprise a valve upper part which is fastened to the upper wall of the ball valve housing and has a central region with a sealed passage through which the shaft is passed.

Preferably, the sealing seats and sealing elements of the ball arrangement held inside the ball valve housing are placed on the inner sides of the housing side walls around the openings of the fluid outlets. According to an advantageous embodiment of the invention, the sealing elements mentioned are O-rings, wherein a respective complementary profile with an annular depression is formed on the inner sides of the housing side walls.

A substantial feature of the invention is that, as mentioned above, the two L-shaped housing parts do not form a full housing. This reduces the amount of material required and—associated therewith—weight and space required in comparison with the cartridge valves known hitherto, but it also makes it possible to choose other production methods without complicated processing. Thus, the L-shaped housing parts can be manufactured by extrusion, which permits mass production, but casting and powder metallurgy or sintering processes are also possible, as a result of which the product can be produced substantially more cost-effectively and competitively than cartridge valves with a full housing. The precise positioning of the two housing parts to be connected is achieved by placing pins or by positioning axes in an assembly tool.

Also, the ball valve according to the invention benefits from the advantages of the known cartridge concept since the ball valve need not be completely enclosed for this purpose. The ball pack also finds sufficient support in the open cartridge housing, the ball valve housing. If the ball valve is inserted as a valve cartridge into a valve block or valve block and the cartridge housing fits exactly into a distributor pocket of the valve block during assembly, the valve cartridge functions as a conventional valve, i.e. a valve with predominantly closed housing walls on all sides.

The invention therefore also relates to a refrigerant valve device which comprises at least one ball valve with the above-mentioned features according to the invention, a drive device for driving the ball valve and a valve block. The valve block in turn comprises at least one downwardly tapering truncated cone-shaped distributor pocket which is formed between two opposite flow line ends adjoining the distributor pocket on a central axis perpendicular thereto in such a way that the distributor pocket can receive the two-part ball valve housing of the ball valve. In addition, the valve block has a further flow line from which a branch leads to a bottom region of the distributor pocket. According to the invention, the two-part ball valve housing is received in the distributor pocket in such a way that in each case one fluid outlet is flush with one of the flow line ends and that the branch of the flow line is flush with the fluid inlet and the bottom opening of the passage channel of the through-flow control ball.

The above-mentioned conical shape of the ball valve housing with a cone angle of approximately 7° ensures that there is no damage to the sealing ring during assembly and insertion of the ball valve into the valve block. The ball valve is fully functional when inserted into the valve block.

A refrigerant flow from the bottom inlet can be directed in the two outlet directions and there is the possibility of regulating the refrigerant flow in one direction. The sealing between the two fluid outlets is also ensured in the distributor pocket.

### DESCRIPTION OF DRAWINGS

Further details, features and advantages of designs of the invention will become apparent from the following description of exemplary embodiments with reference to the associated drawings. Wherein:

FIG. 1A: shows a perspective view of a ball valve,

FIG. 1B: shows an exploded representation of the ball valve,

FIG. 1C: shows a perspective view of a first L-shaped housing part,

FIG. 2: shows a partial section of a housing side wall,

FIG. 3: shows a sectional view of the ball valve with a valve drive device,

FIG. 4A: shows a schematic representation of a first phase of the installation of a ball valve in the refrigerant valve device,

FIG. 4B: shows a schematic representation of a second phase of the installation of the ball valve in the refrigerant valve device, and

FIG. 5: shows a partial sectional view of a refrigerant valve device with an installed ball valve.

### DESCRIPTION OF AN EMBODIMENT

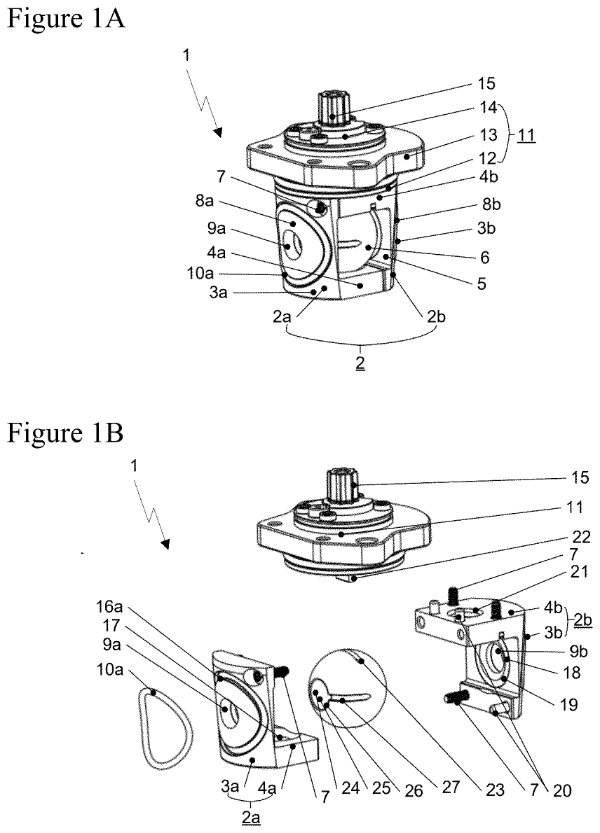

In FIG. 1A, an assembled ball valve 1 of a refrigerant valve device for an air conditioning system is represented. The ball valve 1 comprises a two-part open ball valve housing 2, more precisely a ball valve housing 2 which consists of two housing parts, a first housing part 2a and a second housing part 2b, which each have an L-shaped sectional geometry and are aligned rotationally symmetrically with respect to one another and are connected to one another in such a way that a rectangular sectional geometry results for the ball valve housing 2, in which two respective housing walls 3a, 3b; 4a, 4b are located opposite one another, which do not belong to the same housing part 2a; 2b, but rather to different housing parts 2a, 2b in each case. As a result of the spacing of the respective opposite housing walls 3a, 3b; 4a, 4b, two opposite sides 5 of the ball valve housing 2 remain open, wherein only one open side 5 is visible in FIG. 1A. The two L-shaped housing parts 2a and 2b are clamped together in order to hold a valve ball arrangement, hereinafter also called a valve ball pack, in the interior of the ball valve housing 2, which, in addition to the through-flow control ball 6, comprises sealing seats placed on the inner sides of the housing side walls 3a and 3b and sealing elements, such as, for example, O-rings, which, however, are not visible in FIG. 1A. For this purpose, the two L-shaped housing parts 2a are aligned rotationally symmetrically with respect to one another and are connected at their ends with the help of fastening elements 7, and in the example shown, with the help of screws. The ends of the two L-shaped housing parts 2a, 2b which are connected to one another by means of the fastening elements 7 lie diagonally opposite one another in the ball valve housing 2 and are thus located on different sides of the through-flow control ball 6. Two spaced and mutually opposite housing walls 3a, 3b are curved on their outer side 8a, 8b in the manner of opposite segments of a truncated cone-tapering downwards-and aligned with one another. These housing walls 3a, 3b are also referred to as housing side walls 3a, 3b in the context of the present invention.

The cone angle of these housing side walls 3a, 3b aligned in the manner of mutually opposite truncated cone segments would correspond to half a cone angle of a truncated cone which contains corresponding opposite truncated cone segments and is preferably approximately 7°. The two other spaced and mutually opposite housing walls 4a, 4b of the ball valve housing 2, a bottom wall 4a and an upper housing wall 4b, are connected with their end which is directed towards the respective other housing part 2b; 2a at the end of the inner side of the housing side wall 3b; 3a of the respective other housing part 2b; 2a by means of the fastening elements 7. A fluid inlet of the ball valve 1, which is designed as a 3/2-way valve, is formed in the bottom wall 4a and is covered by the through-flow control ball 6 in the representation of FIG. 1A. In contrast, two fluid outlets are formed in the two housing side walls 3a; 3b opposite one another, wherein in FIG. 1, only one fluid outlet 9a is visible in one of the housing side walls, the housing side wall 3a.

A sealing ring is respectively placed on the conical outer sides 8a, 8b of the two housing side walls 3a, i.e. which are curved in the manner of opposite segments of a truncated cone tapering downwards. As shown in FIG. 1, such a sealing ring 10a extends around the opening of the fluid outlet 9a.

On the upper housing wall 4b of the ball valve housing 2, a valve upper part 11 is fastened which completely covers the upper housing wall 4b with a cylindrical sealing region 12 and projects above this cylindrical sealing region 12 with a plate-shaped region 13 on all sides. Placed in the center of the plate-shaped region 13 is a passage 14 through which a shaft 15 for driving the through-flow control ball 6 is passed.

FIG. 1B shows the parts of the ball valve 1 in an exploded representation. The first housing part 2a is shown without the separately represented sealing ring 10a, as a result of which an annular receiving recess 16a for the sealing ring 10a can be seen on the curved outer side 8a of the housing side wall 3a provided by the first housing part 2a. In addition, the inside of the bottom wall 4a with the centrally positioned fluid inlet 17 formed therein is also visible. The second housing part 2b is represented separately from the through-flow control ball 6 with a view direction on its inner side, as a result of which a valve seat or sealing seat 18 and an inner sealing element 19 are visible on the inner side of the housing side wall 3b of the second housing part 2b as further parts of the valve ball pack, which extend around the opening of the fluid outlet 9b on the housing side wall 3b of the second housing part 2b, concentrically with respect to the opening of the fluid outlet 9b. In the assembled state, the sealing seat 18 rests within the ball valve housing 2 against the through-flow control ball 6.

For precise positioning of the two housing parts 2a and 2b during the assembly process, positioning means 20, for example one or more pins, are also placed in addition to the fastening elements 7, as can be seen in FIG. 1B in the end region of the inner side of the housing side wall 3b which forms an L-leg of the housing part 2b. Corresponding fastening elements 7 and positioning means 20 are also located on the side of the upper housing wall 4b which is directed towards the valve upper part 11 and forms the other L-leg of the second housing part 2b. These fastening elements 7 and positioning means 20 placed on the upper housing wall 4b serve for fastening the valve upper part 11 on the upper housing wall 4b. In the center of the upper housing wall 4b, a passage opening 21 for the passage of the shaft 15 for driving the through-flow control ball 6 is formed. At its end directed towards the through-flow control ball 6, the shaft 15 has an engagement element 22 projecting in the axial direction of the shaft 15, which in the assembled state engages a corresponding recess 23 of the through-flow control ball 6 in order to establish an operative connection between the shaft 15 and the through-flow control ball 6 in such a way that a torque exerted on the shaft 15 can be transmitted to the through-flow control ball 6. The corresponding recess 23 is visible as a slot in the through-flow control ball 6.

A through-flow channel 24 extends through the through-flow control ball 6 with a bottom opening directed towards the fluid inlet 17 in the bottom wall 4a of the first housing part 2a, which is not visible in FIG. 1B, and a lateral opening 25 positioned at a right angle thereto. The through-flow control ball 6 can be rotated about an axis running perpendicular to the bottom wall 4a through the fluid inlet 17 in such a way that the lateral opening 25 of the through-flow control ball 6 can be directed either to the fluid outlet 9a of the housing side wall 3a of the first housing part 2a or to the fluid outlet 9b of the housing side wall 3b of the second housing part 2b or into a closed position.

The lateral opening 25 of the through-flow control ball 6 comprises a round section 26 which transitions into a gap section 27 on one side which extends along the circumference of the through-flow control ball 6 in the direction of rotation of the shaft 15. Due to the construction shown, the ball valve designed as a 3/2-way valve can guide the coolant flow in at least two different directions on the one hand, namely to the fluid outlet 9a in the housing side wall 3a of the first housing part 2a or to the fluid outlet 9b in the housing side wall 3b of the second housing part 2b, on the other hand, due to the lateral opening 25 of the through-flow control ball 6 which is widened by the gap section 27, the coolant flow can be regulated at each of the two fluid outlets 9a and 9b, i.e. in one respective direction.

FIG. 1C shows a perspective view of the first L-shaped housing part 2a, with the bottom wall 4a and the housing side wall 3a as L-limbs, with a view towards the inner walls. The fluid inlet 17 is formed in the bottom wall 4a, while the fluid outlet 9a extends centrally through the housing side wall 3a. A sealing seat 18 with an associated inner sealing element 19 for the through-flow control ball 6 is placed in the housing side wall 3a. Corresponding sealing seats 18 and sealing elements 19 are also located on the second housing part on the second housing side wall. In order to achieve a sufficient sealing with the permissible operating forces, the sealing seats 18 must fit very precisely to this through-flow control ball 6.

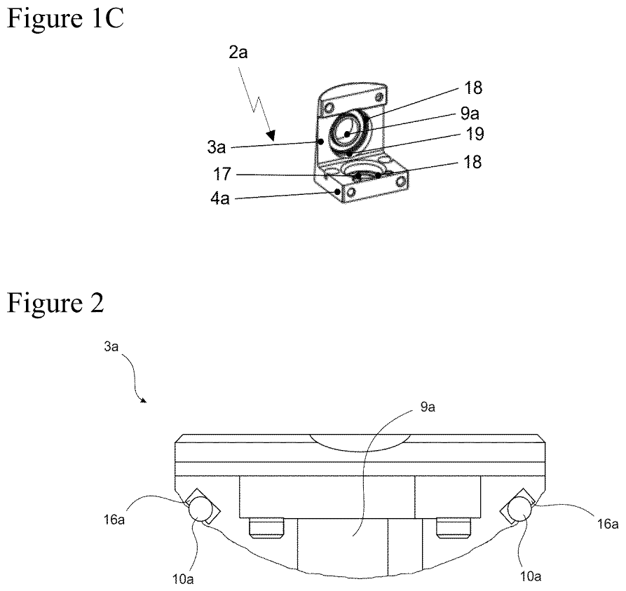

FIG. 2 shows a partial section of a housing side wall, for example the housing side wall 3a, wherein the fluid outlet 9a and in particular the cross sections of the receiving recess 16a and of the sealing ring 10a placed therein are visible on the curved outer side of the housing side wall 3a. In this case, the receiving recess 16a for the sealing ring 10a embodied as an O-ring is formed in such a way that it is aligned perpendicularly to the curved outer surface of the housing side wall 3a in each direction. This means that in the receiving recess 16a, which appears to be U-shaped in cross-section, at each point of the receiving recess 16a, both U-legs extend in each case perpendicularly to the surface of the outer side of the housing side wall 3a or perpendicularly to a tangent of a curvature of the surface of the outer side of the housing side wall 3a which bears against the respective U-leg. This alignment of the recess ensures that the lateral sealing ring 10a or O-ring is neither lost nor able to slip out of the receiving recess 16a. Everything that is described in FIG. 2 for the housing side wall 3a of the first housing part 2a, the sealing ring 10a and the receiving recess 16a also applies in a corresponding manner to the housing side wall of the second housing part and the sealing ring placed there in a receiving recess.

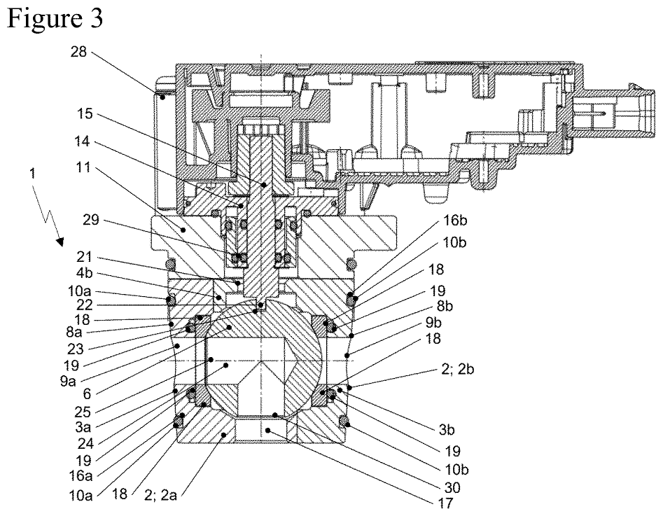

FIG. 3 contains a sectional representation of the ball valve 1 along a sectional plane which shows the two housing parts 2a, 2b which are represented, among other things, by the differently aligned hatches, of the assembled ball valve housing 2, the through-flow control ball 6, the valve upper part 11 with the passage 14 for the shaft 15 and the shaft 15 itself. In addition, FIG. 3 contains a sectional representation of a valve drive device 28 which is put on the valve upper part 11, wherein an operative connection between the valve drive device 28 and the shaft 15 is formed in an end region of the shaft 15 which is located above the valve upper part 11. The shaft 15 is passed through the valve upper part 11 along the passage 14 sealed by several sealing elements 29, passes further through the passage opening 21 in the upper housing wall 4b of the ball valve housing 2 and finally engages with its axially projecting engagement element 22 in the corresponding recess 23 of the through-flow control ball 6 in order to enter into an operative connection with the through-flow control ball 6. As shown in the sectional representation of FIG. 3, the through-flow channel 24 within the through-flow control ball 6 is formed to be rectangular or L-shaped, so that the lateral opening 25 of the through-flow control ball 6 is orientated at a right angle to the bottom opening 30. While the bottom opening 30 is thus directed toward the fluid inlet 17 in each rotational position of the through-flow control ball 6, the position of the lateral opening 25 of the through-flow control ball 6 with respect to the fluid outlets 9a and 9b can be changed by a rotation of the shaft 15. In the position represented, the lateral opening 25 of the through-flow control ball 6 is directed towards the fluid inlet 9a of the first housing part 2a. By rotating the through-flow control ball 6 through 180°, the lateral opening 25 can be aligned in the direction of the fluid outlet 9b of the second housing part 2b and thus the direction of the fluid flow can be changed. By means of rotation of the through-flow control ball 6, for example, the through-flow of a chemical refrigerant in a motor vehicle air conditioning system can be regulated.

Inside the ball valve housing 2, the valve ball arrangement or valve ball pack held by the two housing parts 2a, 2b is represented, which, in addition to the through-flow control ball 6, comprises sealing seats 18 placed on the inner sides of the housing side walls 3a and 3b and inner sealing elements 19 in the form of O-rings. The two sealing seats 18 are placed on the two opposite sides of the through-flow control ball 6 in such a way that they rest against the through-flow control ball 6. The inner sealing elements 19 are formed in the shape of O-rings, wherein a complementary profile with an annular recess for receiving one of the sealing elements 19 is formed on the inner sides of the housing side walls 3a, 3b.

A sealing ring 10a; 10b is respectively placed in a corresponding receiving recess 16a; 16b on the conical, i.e. on the-in the manner of opposite segments of a downwardly tapering truncated cone-curved and aligned outer sides 8a, 8b of the two housing side walls 3a, 3b. As shown in the sectional representation in FIG. 3, a sealing ring 10a extends around the opening of the fluid outlet 9a and a further sealing ring 10b extends around the opening of the opposite fluid outlet 9b.

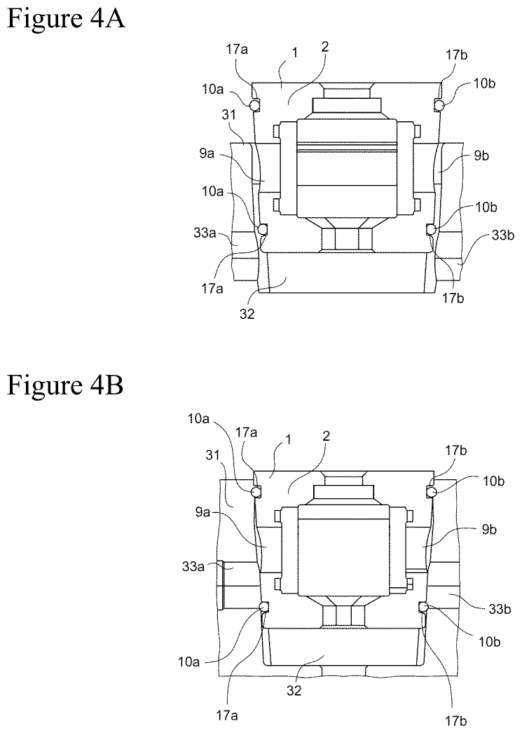

In FIG. 4A and FIG. 4B, the assembly, i.e. the installation of a ball valve 1 as a cartridge in a valve block 31 of a refrigerant valve device, is represented schematically. A downwardly tapering truncated distributor pocket 32 is formed within the valve block 31 between opposite flow line ends 33a, 33b on a central axis perpendicular thereto in such a way that it can receive the two-part ball valve housing 2 of the ball valve 1. The ball valve 1 benefits from the advantages of the cartridge concept in that the valve ball arrangement does not have to be completely enclosed, but can be held in an open-designed ball valve housing 2. When the ball valve 1 is inserted into the distributor pocket 32 of the valve block 31, the ball valve 1 functions as a conventional valve since the open ball valve housing 2 fits completely into the distributor pocket 32 during assembly, as can be seen in FIG. 4A and FIG. 4B. The opposite housing side walls 3a and 3b of the ball valve housing 2 are designed on their outer sides in the manner of segments of a downwardly tapering truncated cone, i.e. conically, which ensures that the sealing rings 10a and 10b placed on the outer sides are not damaged during the assembly or installation of the ball valve 1 into the valve block 31. The cone angle is preferably about 7°. By virtue of the fact that the receiving recesses 16a, 16b for the sealing rings 10a, 10b, which are each embodied as an O-ring, are formed in such a way that they are aligned perpendicularly in each direction with respect to the curved outer surface of the housing side wall 3a; 3b, in which the corresponding receiving recess 16a; 16b is formed, it is ensured that the lateral sealing rings 10a, 10b cannot be lost or slip out of the receiving recesses 16a, 16b during assembly.

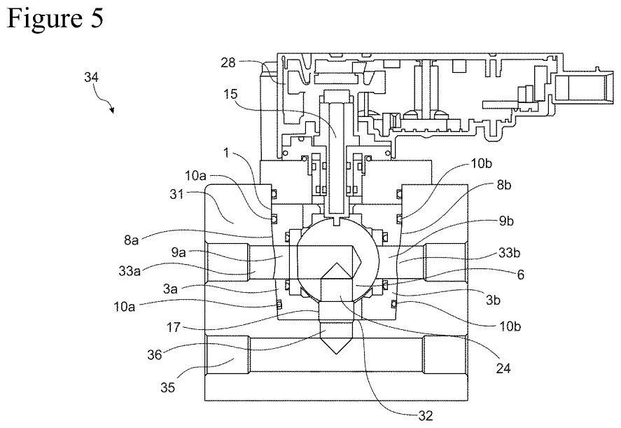

Finally, FIG. 5 shows a partial sectional representation of a refrigerant valve device 34

which comprises a ball valve 1, a valve block 31 and a valve drive device 28. The ball valve 1 is completely inserted into the truncated distributor pocket 32 of the valve block 31 which is arranged between two mutually opposite flow line ends 33a and 33b adjoining the distributor pocket 32, wherein the flow line ends 33a and 33b have the same diameter as the fluid outlets 9a and 9b of the ball valve 1. Due to the complete reception of the ball valve 1 in the at least one truncated distributor pocket 32, the fluid outlets 9a and 9b are flush with the respectively adjacent flow line end 33a; 33b. Below the distributor pocket 32, a further flow line 35 is arranged in the valve block 31 parallel to the flow line ends 33a and 33b, from which a branch 36 leads to a bottom region of the distributor pocket 32. This branch 36 has the same diameter as the fluid inlet 17 in the bottom wall 4a of the ball valve 1, wherein the branch 36 of the flow line 35 is flush with the fluid inlet 17 and the bottom opening 30 of the through-flow channel 24 of the through-flow control ball 6 due to the complete reception of the ball valve 1 in the distributor pocket 32. If the ball valve 1 embodied as a 3/2-way valve is installed in the valve block 31 of the refrigerant valve device 34, it is fully functional. A refrigerant flow flowing in from the fluid inlet 17 of the bottom wall 4a can be directed into the two opposite directions of the different fluid outlets 9a and 9b by means of rotation of the shaft 15 in operative connection with the through-flow control ball 6 due to the rectangular shape of the through-flow channel 24. In addition, it is possible to regulate the refrigerant flow in one direction. The sealing between the two fluid outlets 9a and 9b is also ensured in the distributor pocket 32 by means of sealing rings 10a and 10b which are placed around the openings of the fluid outlets 9a and 9b on the curved outer sides 8a, 8b of the housing side walls 3a, 3b.

The invention relates to a ball valve of a refrigerant valve device for an air conditioning system, in particular a motor vehicle air conditioning system.

1-10. (canceled)

11. A ball valve of a refrigerant valve device for an air conditioning system, the ball valve comprising:
a ball valve housing of two housing parts which each have an L-shaped cross-sectional geometry, are aligned rotationally symmetrically to one another, and which are connected to one another at their ends with the help of fastening elements to form a ball valve housing with a rectangular cross-sectional geometry, with two opposite housing side walls, a bottom wall and with an upper housing wall opposite the bottom wall and with two mutually opposite open sides, wherein the ball valve housing has a fluid inlet formed in the bottom wall and two fluid outlets respectively formed in the two opposite housing side walls,
a ball arrangement which contains a through-flow control ball and sealing seats and inner sealing elements and is held together by the ball valve housing, wherein a through-flow channel with a bottom opening directed towards the fluid inlet and with a lateral opening extends through the through-flow control ball, and wherein the through-flow control ball is rotatable about an axis perpendicular to the bottom wall and thereby a position of the lateral opening of the through-flow control ball with respect to the fluid outlets is adjustable, and wherein the two opposite housing side walls are curved and aligned on their outer sides in a manner of two opposite segments of a downwardly tapering truncated cone, and wherein a respective one of a sealing ring is attached to each of the curved and aligned outer sides of the two opposite housing side walls which extends around an opening of the fluid outlets in a corresponding one of the two opposite housing side walls.

12. The ball valve according to claim 11, wherein a respective annular receiving recess for the respective one of the sealing rings is formed on the curved and aligned outer sides of the two opposite housing side walls of the ball valve housing.

13. The ball valve according to claim 12, wherein on the curved and aligned outer sides of the two opposite housing side walls the respective annular receiving recess for the respective one of the sealing rings is formed in such a way that the respective annular receiving recess is aligned perpendicularly in each direction to a surface of the curved and aligned outer sides.

14. The ball valve according to claim 11, wherein a cone angle of the ball valve housing which tapers conically in a region of its curved and aligned outer sides is 7+0.5°.

15. The ball valve according to claim 11, further comprising a shaft for driving the through-flow control ball, wherein the shaft is passed through a center of the upper housing wall by means of a passage opening and connected to the through-flow control ball or is in an operative connection with the through-flow control ball.

16. The ball valve according to claim 15, further comprising a valve upper part which is secured to the upper housing wall of the ball valve housing and has a central region with a sealed passage through which the shaft is passed.

17. The ball valve according to claim 15, wherein the operative connection between the shaft and the through-flow control ball is realized in that the shaft has, at its end directed towards the through-flow control ball, an engagement element which projects in an axial direction of the shaft and engages a corresponding recess of the through-flow control ball.

18. The ball valve according to claim 11, wherein the sealing seats and inner sealing elements of the ball arrangement held in an interior of the ball valve housing are placed on inner sides of the two opposite housing side walls around the opening of the fluid outlets.

19. The ball valve according to claim 18, wherein the inner sealing elements are O-rings and a respective complementary profile with an annular depression is formed on the inner sides of the two opposite housing side walls.

20. The refrigerant valve device, comprising:
at least one of the ball valves according to claim 11,
a valve drive device for driving the at least one of the ball valve,
a valve block with at least one downwardly tapering truncated distributor pocket which is formed between two opposite flow line ends adjoining the distributor pocket on a central axis perpendicular thereto in such a way that the distributor pocket can receive the ball valve housing of the ball valve, and with a flow line of which a branch leads to a bottom region of the distributor pocket, wherein the ball valve housing is received in the distributor pocket in such a way that a respective one of the two fluid outlets is flush with one of the two opposite flow line ends and that the branch of the flow line is flush with the fluid inlet and the bottom opening of the through-flow channel of the through-flow control ball.
